(19) United States
(12) Patent Application Publication
(10) Pub. No.: US 2003/0057295 A1
(43) Pub. Date: Mar. 27, 2003

(54) Reversing valve for a high pressure spray gun

(75) Inventor: Burkhard Helmig, Beckum (DE)

Correspondence Address: Barnes & Thornburg, 750 17th Street, N.W., 9th Floor, Washington, DC, 20006, US

(73) Assignee: Hammelmann Maschinenfabrik GmbH

(21) Appl. No.: 10/196,359

(22) Filed: Jul. 17, 2002

(30) Foreign Application Priority Data
Jul. 20, 2001 (DE) 101 35 563.7

(51) Int. Cl. B05B 9/00

(52) U.S. Cl. 239/124; 239/127; 137/596

(57) ABSTRACT

A reversing valve for a high pressure spring gun, comprising: a pump connection; a connecting duct; a first section of the connecting duct connected to the pump connection; a second section of the connecting duct leading to a high pressure discharge; a block valve, being a transition between the first and second sections, that can be isolated by switching off the high pressure gun; a throttle, linked with the first section of the connecting duct to let fluid through; an exhaust duct linked to the throttle and leading to a drain; and a discharge valve operated by an electric switch to isolate the exhaust duct when the high pressure spray gun is switched on.

### BACKGROUND AND SUMMARY OF INVENTION

Priority is claimed to German Patent Application No. 101 35 563.7, filed Jul. 20, 2001.

This invention concerns a reversing valve for a high pressure spray gun.

Reversing valves are used where several high pressure spray guns are connected to a common pump. When switching off one of the connected high pressure spray guns, pressure is still needed to operate the other gun(s). The pressure flow in excess of that needed by the currently used gun(s) can be rerouted by means of a choker valve.

To achieve this, it is known to provide a spool valve in the reversing valve in order to convey the excessive flow to the choker valve.

Because of the high operating pressure, that may be as high as 3000 bars and because of the switching operations, the spool valve is exposed to extreme loads. This can cause significant wear and tear, for example so-called seizure, which limits the functionality of the spool valve notably.

This invention develops a reversing valve which enables absolute safe operation of the high pressure spray guns, particularly in closed position, while improving its service life significantly.

The present invention is directed to a reversing valve for a high pressure spring gun, comprising: a pump connection; a connecting duct; a first section of the connecting duct connected to the pump connection; a second section of the connecting duct leading to a high pressure discharge; a block valve, being a transition between the first and second sections, that can be isolated by switching off the high pressure gun; a throttle, linked with the first section of the connecting duct to let fluid through; an exhaust duct linked to the throttle and leading to a drain; and a discharge valve operated by an electric switch to isolate the exhaust duct when the high pressure spray gun is switched on.

An embodiment of the present invention guarantees safe switching off of a hand-held high pressure spray gun, thereby also avoiding an accidental start as well as any interactions when switching on and off other high pressure spray guns that may be fed by a common pump.

A throttle, unlike those observed in the state of the art, is composed of two components positioned in a certain way in relation to one another, whereby a choke gap is formed by a journal fixed with respect to a sleeve, which journal rests on a bearing inside the sleeve with a given clearance. The choke gap is reduced by an inlet pressure, i.e. the pump-generated pressure, to the extent that a medium is discharged from a drain with practically zero pressure. This design enables the conversion of pressure energy into heat energy so that the medium leaving the drain, normally water, can reach a temperature of approximately 90° and more, with an inlet pressure of approximately 3000 bars.

When the spray gun is not in use, the medium exposed to the inlet pressure is conveyed to a throttle or choke and from there through a discharge valve to a drain. The discharge valve is operated by a pneumatic valve which is controlled by an electric switch that is usually provided on a handle of the high pressure spray gun. The electric switch, being in the off position, causes a pneumatic valve to be disconnected from a discharge or drain valve which allows medium flow from the pump to go through the discharge valve to the drain.

When the discharge valve is open, the block valve is closed, isolating the first section from the second section of the connecting duct.

The open position of the discharge valve drives the medium, subject to high pressure, first through the throttle, where its pressure is reduced and then through the exhaust or drain duct to the drain.

Any heated, low pressure medium output through the throttle is prevented from reaching the high pressure spray gun via the second section of the connecting duct, because a non-return valve is laid out in the area of the second section between the block valve and the spray gun.

Since, as mentioned previously, the pressure-reduced medium shows a very high temperature, no damage is inflicted to the high pressure spray gun, normally fitted with a delivery hose made of synthetic material. The service life of such delivery hose is therefore increased significantly.

When it is desired to use the spray gun, the electric switch is turned on causing the pneumatic valve to be connected to the discharge valve. That shuts off the discharge valve and prevents flow of the medium to the drain. The blocked flow to the drain causes the block valve to move from its normally closed position to an open position. This then permits the block valve to open enabling high pressure medium from the pump to flow through the block valve, opening a non-return valve and then flowing to a spray gun discharge.

The block valve and the non-return valve are spring-loaded in a closed position.

The throttle and the valves are adjustable to suit various pressure outputs and the number of spray guns connected to the pump.

As described, this invention improves the operating safety of the reversing valve as well as the operating safety of the high pressure spray gun. Moreover, thanks to the minimal pressure variations produced after successive switching operations of the multiple connections, there is no significant back kick, unlike previous systems. This design improves not only the service life of the corresponding components of the reversing valve, but also the degree of safety for the person using the high pressure spray gun.

Other aspects, advantages and novel features of the present invention will become apparent from the following detail description of the invention when considered in conjunction with the accompanying drawings.

### BRIEF DESCRIPTION OF THE DRAWINGS

FIG. 1 shows a side view of a reversing valve, according to the invention,

FIG. 2 shows a wiring diagram of the reversing valve.

### DETAILED DESCRIPTION OF THE PREFERRED EMBODIMENTS

FIG. 1 shows a reversing valve 20 for a high pressure spray gun (not shown), comprising a valve casing 16 to which is arranged a pump connection 1 as well as a block valve 3, a throttle 4, a discharge 6, a drain or discharge 8 as well as an electric discharge valve 9. A non-return valve 5 is provided in the area of the discharge 6.

FIG. 2 shows a connecting duct 12 connected to block valve 3. The connecting duct 12 is composed of a first section 13 and of a second section 14 between which the block valve 3 is located. The first section 13 is connected to the pump connection 1, whereas the second section 14 leads to the discharge 6. When the high pressure spray gun is switched off, the flow of the medium M is blocked between the first section 13 and the second section 14.

The throttle 4 is linked with the first section 13 inasmuch as it lets fluid flow through first section 13. The throttle 4 is also linked with an exhaust duct 15 that reaches into the discharge or drain 8.

FIG. 2 shows the condition when the high pressure spray gun is switched off. It should be noted that the electric switch 7 is in the off position. The discharge valve 9 is in the open position and the block valve 3 is in the closed position thereby preventing any medium M flow through the connecting duct 12.

The medium M under pressure is conveyed through the throttle 4 where the pressure is reduced. The depressurized medium M is driven to the exhaust duct 15 and through the open discharge valve 9 and then to the drain 8.

The non-return valve 5 isolates the connecting duct 12 from the discharge 6 by preventing depressurized and heated medium M from flowing to the spray gun.

Discharge or drain 8 can be isolated by switching the high pressure spray gun on using electric switch 7.

When the electric switch 7 is turned on (not shown), this causes pneumatic valve 11 to connect with and cause discharge valve 9 to close, which shuts off the discharge valve 9 and prevents flow of medium M to drain 8. That builds up a pressure in the isolated second section 14 of the connecting duct 12, which acts on and enables block valve 3 to open allowing medium M to flow through the connecting duct 12. The non-return valve 5 is opened by the existing operating pressure, the throttle 4 is by-passed and medium M flows to the spray gun.

Alternatively, the discharge valve 9 may be operated hydraulically or electromagnetically or by other equivalent devices.

Although the present invention has been described and illustrated in detail, it is to be clearly understood that this is done by way of illustration and example only and is not to be taken by way of limitation. The spirit and scope of the present invention are to be limited only by the terms of the appended claims.

We claim:

1. A reversing valve for a high pressure spring gun, comprising:
a pump connection;
a connecting duct;
a first section of the connecting duct connected to the pump connection;
a second section of the connecting duct leading to a high pressure discharge;
a block valve, being a transition between the first and second sections, that can be isolated by switching off the high pressure gun;
a throttle, linked with the first section of the connecting duct to let fluid through;
an exhaust duct linked to the throttle and leading to a drain; and
a discharge valve operated by an electric switch to isolate the exhaust duct when the high pressure spray gun is switched on.

2. The reversing valve according to claim 1, wherein a non-return valve is provided to isolate the second section of the connecting duct when the high pressure spray gun is switched off.

3. The reversing valve according to claim 1, wherein the discharge valve can be operated by one or more of pneumatically, hydraulically and electromagnetically.

4. The reversing valve according to claim 2, wherein a block valve and the non-return valve are spring-loaded in a closed position.

5. The reversing valve according to claim 1, wherein a pressure drop across the throttle is adjustable.

6. The reversing valve according to claim 4, wherein the block valve, the non-return valve and the discharge valve are adjustable according to pressure.
